(19) United States
(12) Patent Application Publication
(10) Pub. No.: US 2009/0286205 A1
(43) Pub. Date: Nov. 19, 2009

(54) Prefabricated Dental Crowns

(76) Inventors: Jason K. Johnson, Houston, TX (US); D. Johnson Krueger, Houston, TX (US)

Correspondence Address: MARK A OATHOUT, 3701 KIRBY DRIVE, SUITE 960, HOUSTON, TX, 77098, US

(21) Appl. No.: 12/510,245

(22) Filed: Jul. 27, 2009

Related U.S. Application Data
(63) Continuation-in-part of application No. 11/677,574, filed on Feb. 21, 2007.
(60) Provisional application No. 60/775,168, filed on Feb. 21, 2006.

(51) Int. Cl. A61C 5/09; A61C 13/08

(52) U.S. Cl. 433/222.1; 433/202.1

(57) ABSTRACT

Advanced material is preferably used for the manufacturing of dental crowns which may be used to restore decayed or to protect other compromised tooth structure. The dental crowns are preferably preformed or prefabricated with a strengthener by way of either (1) a metal crown base (for example, a stainless steel crown base) having an advanced material (which may include fillers) applied coating or layer; or (2) an advanced material with a strengthener in the form of a strip and/or fillers. In either of the foregoing, or independently, the advanced material may be formed or applied by flame spray, liquid dispersion, powder coating, compression molding, vacuum forming, injection molding, pressure forming, or thermoforming.

### CROSS-REFERENCE TO RELATED APPLICATIONS

This application is a continuation-in-part of U.S. patent application Ser. No. 11/677,574 filed Feb. 21, 2007, which claims the benefit of U.S. provisional application No. 60/775,168 filed Feb. 21, 2006.

### FEDERALLY SPONSORED RESEARCH OR DEVELOPMENT

Not applicable.

### REFERENCE TO LISTING, TABLES OR COMPACT DISK APPENDIX

Not applicable.

### SUMMARY

The term “advanced material” as used herein shall mean advanced, specialty, high performance, engineering plastics, thermoplastic—TPE or thermoset—TPV resins, polymers, copolymers, composites or compounds such as, polyacrylate, polyamide, polyaryletherketone, polyetheretherketone—(also known as PEEK), polyetherimide, polyketone, polysulfone, ultra high molecular weight polyethylene—UHMWP(E) polyetherketoneketone (also known as PEKK), and polyphenylene sulfide (also known as PPS) and other formulations, mixtures or mixtures thereof which may also include a filler or strengthening material.”

The term “undercut” as used herein shall mean the circumferential area of the dental crown being formed for mechanical retention.

The term “center surface” shall apply to both a surface of a dental crown consisting of an occlusal area or an incisal area depending on whether the respective dental crown is an anterior or a posterior dental crown.

Advanced material is preferably used for the manufacturing of dental crowns which may be used to restore decayed or to protect other compromised tooth structure. The dental crowns are preferably preformed or prefabricated with a strengthener by way of either (1) a metal crown base (for example, a stainless steel crown base) having an advanced material (which may include fillers) applied coating or layer; or (2) an advanced material with a strengthener in the form of a strip and/or fillers. In either of the foregoing, or independently, the advanced material may be formed or applied by flame spray, liquid dispersion, powder coating, compression molding, vacuum forming, injection molding, pressure forming, or thermoforming.

### BRIEF DESCRIPTION OF THE SEVERAL VIEWS OF THE DRAWINGS

FIG. 1 is an elevation, sectional view of a posterior embodiment of a dental crown bonded or cemented over a posterior tooth.

FIG. 2 is an elevation, sectional, side view of an anterior embodiment of a dental crown bonded or cemented over an anterior tooth.

FIG. 3 is a sectional view taken along line 3-3 of FIG. 2 save that the crown only is shown (no tooth, no cement).

FIG. 4 is a plan view of one embodiment of a strip for an anterior crown.

FIG. 5 is a plan view of another embodiment of a strip for a posterior crown.

FIG. 6 is a plan view of another embodiment of a strip.

FIG. 7 is a plan view of another embodiment of a strip.

FIG. 8 is a plan view of another embodiment of a strip.

FIG. 9 is sectional view of the dental crown of FIG. 1, without the cement and tooth, showing an embedded strip curled at the ends.

FIG. 10 is an elevation sectional view of a dental crown embodiment having a coated layer from an advanced material.

### DESCRIPTION OF EMBODIMENT(S) SHOWN IN THE DRAWINGS

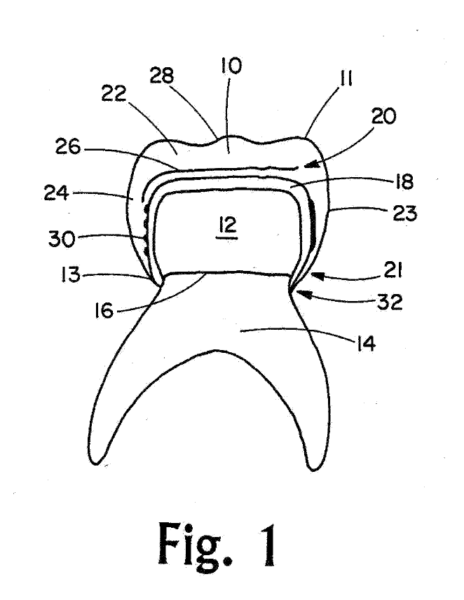

Referring to FIG. 1, a dental crown 10 made of advanced material is shown. The dental crown 10 could be manufactured of one-hundred percent advanced material or of mixtures thereof. The dental crown 10 may include internal compounded, mixed in or embedded strengthener(s) or fortification(s) 20. The strengthener(s) may be used or placed for localized strengthening or throughout the advanced material. The dental crown 10 is prefabricated in various sizes (for example, three to ten sizes per tooth 12). The various size dental crowns 10 are normally assembled into kits for primary or permanent dentition made available to dentists or the like. The advanced material may include fillers for radiopacity and/or pigments for tinting to match common primary or permanent dentition shades.

A dentist will bond or cement the dental crown 10 to a tooth 12. The tooth 12 shown in FIG. 1 is a posterior tooth. Accordingly, the dental crown 10 shown in FIG. 1 is a posterior dental crown. The tooth 12 has a root 14 and emerges from the gums at the gum-line 16. A layer 18 of glass ionomer (“GI”) or other dental cement may be used by the dentist to apply and bond the dental crown 10 to the tooth 12 above and typically slightly below the gum-line 16 of the patient.

The exterior 11 of the dental crown 10 has an occlusal area (or surface) 22 transitioning into an integral circumferential area (or continuous wall) 24. Normally the circumferential area 24 has slight flexibility (although stiff) toward the gingival end 13 prior to application of the dental crown 10 to a tooth 12. The exterior 11 of the dental crown 10 is preferably toothlike or dentiform in appearance and shape.

As mentioned, the dental crown 10 preferably includes one or more strengthener(s) 20. The strengthener 20 may, for example, be a metal crown base 60 (see FIG. 10). Strip 26 is another type of strengthener 20 and may be embedded (i.e. internalized or suspended within the mass of advanced material) in the occlusal area 22, and/or may be embedded in circumferential area 24. Strip 26 depicts a metal, possibly stainless steel strip having a thickness of about/ranging 0.1-0.25 mm. The strengthener 20 or strip 26 could also be made of bio-compatible metals or non-metals, mesh/screen, fibers, woven fibers, aramids such as KEVLAR (a brand of material available from DuPont), preimpregnated carbon-polymer tapes or other bio-compatible material suitable for strength, and to prevent wear through from the opposing dentition. The strengthener 20 may also comprise combinations of the foregoing. Strip(s) 26 may have perforations 25 or other retentive texturing 27. The perforations 25 or texturing 27 may add flexibility to the strip 26 or areas of retention of the advanced material. For mechanical retention of the advanced material, strip(s) in the form of mesh could be attached to a metal crown base 60. The strip(s) 26 may extend (see FIG. 6) into the interproximal and/or buccal/lingual circumferential area 24 of the crown 10 (i.e. contour with the surfaces 11 and/or 15 of the dental crown 10). The strips may have curved or straight edges or other configurations and shapes to accommodate the fit into the crown.

The strengthener 20 may also, for example, include chopped, short or continuous carbon fibers, glass fibers or particles, plastic, aramid or other fillers, particles or fibers 29 that are compounded or mixed in, embedded, laid-in, or affixed within the dental crown 10 advanced material. The strengtheners 20 may be used or placed for localized strengthening or throughout the advanced material with or without in conjunction with strip(s) 26 or metal crown base 60.

The occlusal area 22 has a total thickness ranging from 1.0 to 3.0 millimeters. In the embodiment shown in FIG. 1, the distance from the occlusal surface 28 to the strip 26 is, for example, about 0.75-2.0 millimeters. The strip(s) 26 or metal crown base 60 may possibly be exposed on the internal surface (or cavern side 15) in one or more areas.

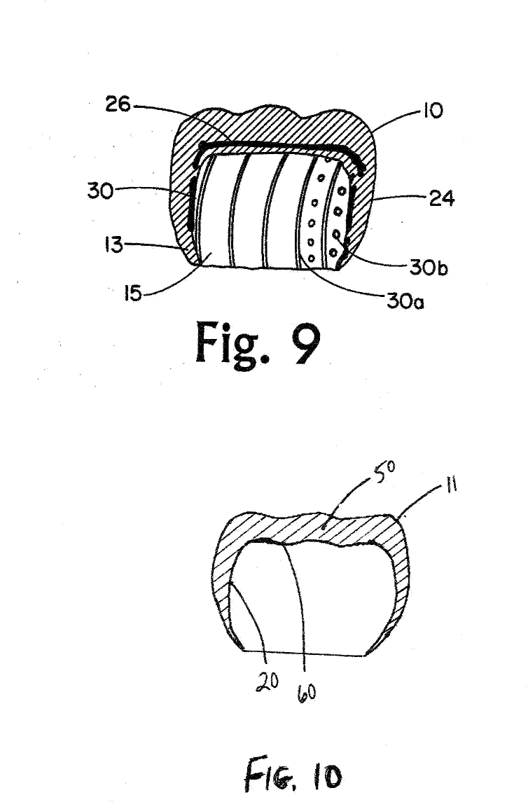

Grooves 30, indentations 30a and/or dimples 30b (only a few shown by way of example) may be created within the cavern side 15 (see FIG. 1 and FIG. 9) and/or internal circumferential area 24 of the dental crown 10. These grooves 30, indentations 30a and/or dimples 30b by way of example, may be arranged around the cavern side 15 of the internal circumferential area 24 respective to the sides of the tooth 12. The grooves 30, indentations 30a and/or dimples 30b add an enhanced surface for aiding in the bonding or cementing of the dental crown 10 to the tooth 12.

The external surface 11 of the circumferential area 24 of the crown 10 may have a crest (apex) 23 of contour. Regardless, the circumferential area 24 will taper toward the gingival end 13. If applicable, the crest 23 normally runs around the entire circumferential area 24. The taper 21 is inwardly arcuate (toward the gingival edge 32) in the normal case although not required. Near the gingival surface or edge 32 of the dental crown 10, toward the gingival taper 13, the total thickness of the advanced material ranges from 0.0-0.5 millimeters at the gingival edge 32, whilst the total thickness tapers outward to a range of about 1.0-3.0 millimeters proximate the occlusal area 22. The taper 21 may contour to undercut the tooth 12 near the gum-line 16 by from two to thirty-five degrees from a line vertical to the cavern side 15 of the dental crown 10. Such contour to undercut the tooth 12 near the gum-line 16 by from two to thirty-five degrees from a line vertical to the cavern side 15 may run around the entire circumferential area 24, but it may be limited to sections only of the circumferential area 24.

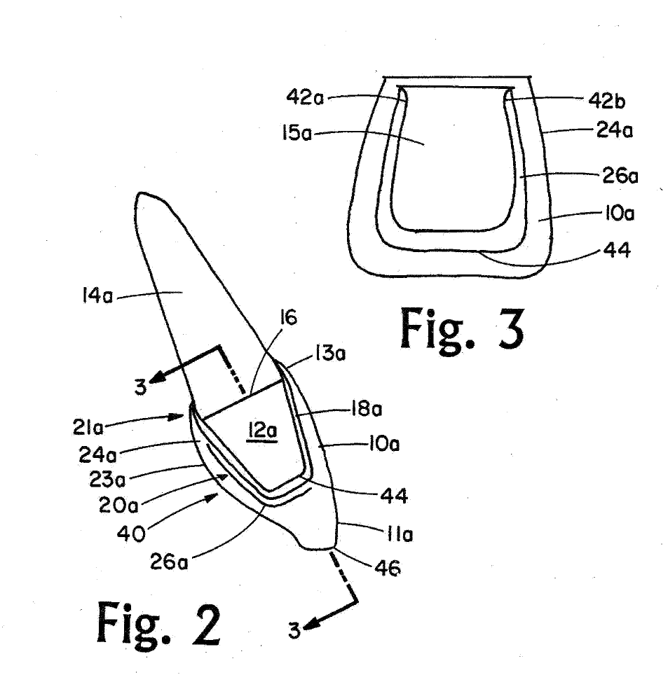

Referring to FIGS. 2-3, a dental crown 10a made of advanced material is shown. The exterior 11a of the dental crown 10a is preferably toothlike or dentiform in appearance and shape. The dental crown 10a may include internal compounded, mixed in or imbedded strengthener(s) 20a. The strengthener(s) 20a, as before, may include a metal crown base, strips, and/or fillers. The strengtheners 20a may be used or placed for localized strengthening or throughout the advanced material. The dental crown 10a is prefabricated in various sizes (for example, three to ten sizes per tooth 12a). The various size dental crowns 10a are normally assembled into kits for primary or permanent dentition made available to dentists or the like. The advanced material may include fillers for radiopacity, and/or pigments for tinting to match common primary or permanent dentition shades.

The exterior 11a of the dental crown 10a has an incisal area (or surface) 46 transitioning into an integral circumferential area (or continuous wall) 24a. Normally the circumferential area 24a has slight flexibility (although stiff) toward the gingival end 13a prior to application of the dental crown 10a to a tooth 12a.

A dentist will bond the dental crown 10a to a tooth 12a. The tooth 12a shown in FIG. 2 is an anterior tooth. Accordingly, the dental crown 10a shown in FIGS. 2-3 is an anterior dental crown. The tooth 12a has a root 14a and emerges from the gums at the gum-line (gingival edge) 16. A layer 18a of glass ionomer (“GI”) or other dental cement may be used by the dentist to apply and bond the dental crown 10a to the tooth 12a above and slightly below the gum-line 16 of the patient.

The strengthener 20a may, for example, be a metal crown base. Strip 26a is another type of a strengthener 20a and may be embedded (i.e. internalized or suspended within the mass of advanced material) in the dental crown 12a from the lingual back-side surface 40 and hooking around the incisal area 44, possibly around the interproximal sides 42a and 42b, and/or may be embedded in circumferential area 24a. Strip 26a depicts a metal, possibly stainless steel strip having a thickness of about/ranging 0.1-0.25 mm. The strengthener 20a or strip 26a could also be made of bio-compatible metals, or non-metals, mesh/screen, fibers, woven fibers, aramids such as KEVLAR (a brand of material available from DuPont), preimpregnated carbon-polymer tapes or other bio-compatible material suitable for strength, and to prevent wear through from the opposing dentition. The strengthener 20a could also be combinations of the foregoing.

Strip(s) 26a may have perforations 25 or other retentive texturing 27. The perforations 25 or texturing 27 may add flexibility to the strip 26a or areas of retention of the advanced material. For mechanical retention of the advanced material, strip(s) in the form of mesh could be attached to a metal crown base 60. The strip(s) 26a may extend (see FIG. 2) into the interproximal, incisal, gingival and/or facial/lingual circumferential area 24a of the crown 10a (i.e. contour with the surfaces 11a and/or 15a of the dental crown 10a). The strips may have curved or straight edges or other configurations and shapes to accommodate the fit into the crown.

Accordingly the strengthener 20a may also, for example, include chopped, short or continuous carbon fibers, glass fibers or particles, plastic, aramid or other fillers, particles or fibers that are compounded or mixed in, embedded, laid-in, or affixed within the dental crown 10a advanced material. The strengtheners may be used or placed for localized strengthening or throughout the advanced material with or without in conjunction with strip(s) 26a or a metal crown base 60.

Grooves, indentations and/or dimples (not shown but the same in nature as described with respect to FIG. 9) may be created within the cavern side 15a (see FIG. 3) and/or internal circumferential area 24a of the dental crown 10a.

The external surface 11a of the circumferential area 24a of the crown 10a may have a crest (apex) 23a of contour on one or more sides. Regardless, the circumferential area 24a will taper toward the gingival end 13a. The taper 21a is inwardly arcuate in the normal case although not required. The incisal area 44 of the crown 10a has a total thickness ranging from 1.0 to 4.0 millimeters. In the embodiment shown in FIGS. 2-3, the distance from the incisal surface 46 and lingual back-side surface 40 to the nearest point of the strip 26a or metal crown base 60 is about 0.75 millimeters. The strip(s) 26a or metal crown base 60 may possibly be exposed on the internal surface (or cavern side 15a) in one or more areas. From the incisal area 44, the thickness of the dental crown 10a tapers down to the gum-line 16 (and may contour to undercut the tooth 12a near the gum-line 16). The total thickness of the advanced material ranges from 0.0-0.5 millimeters proximate the gum-line 16, whilst the total thickness tapers outward toward a range of about 1.0-4.0 millimeters. The taper 21a may contour to undercut the tooth 12a near the gum-line 16 by from two to thirty-five degrees from a line vertical to the cavern side 15a of the dental crown 10a (when the major axis of the dental crown 10a is vertical, albeit shown slanted in FIG. 2). Such contour to undercut the tooth 12a near the gum-line 16 by from two to thirty-five degrees from a line vertical to the cavern side 15a may run around the entire circumferential area 24a, but it may be limited to sections only of the circumferential area 24a.

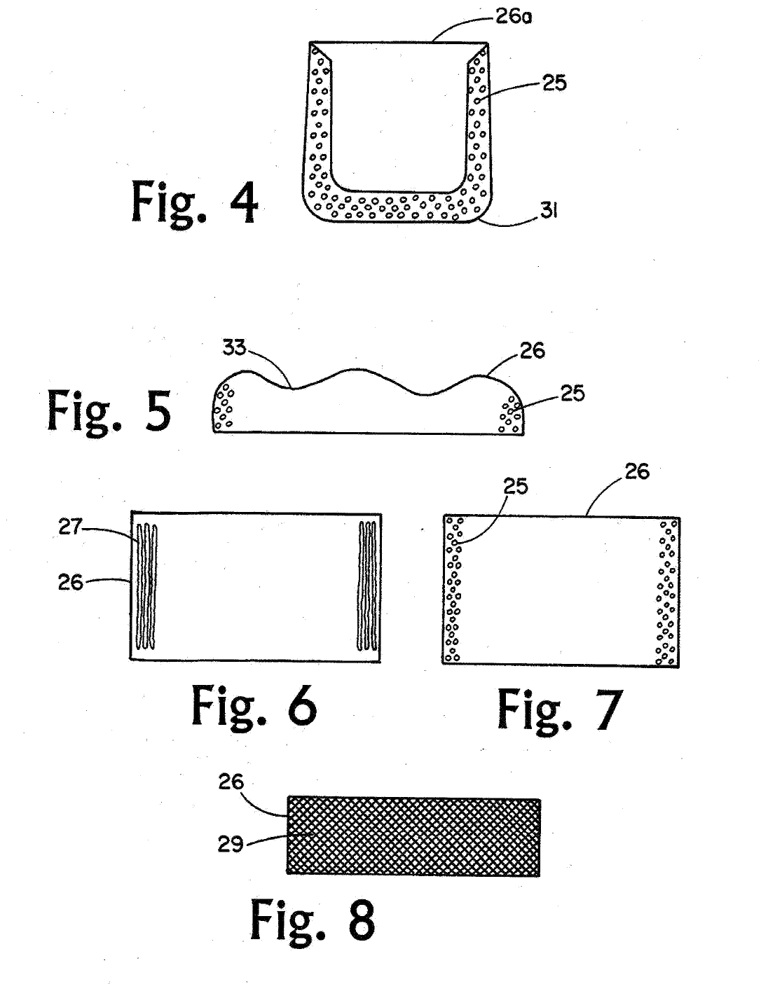

Other types of strengtheners 20 or 20a for strength, support, and/or to prevent wear through may be added to the dental crown 10 or 10a. It may be possible to exclude the strengthener(s) 20 or 20a from the respective dental crown 10 or 10a depending upon the characteristics of the material, fillers which may be added to the materials, adequate thickness in the chewing surface area of the crown and/or manufacturing techniques. Various embodiments or strips 26 or 26a are shown in FIGS. 4-8. Strips 26 and/or 26a may have rounded or chamfered corners 31 and edges. FIG. 5 shows an embodiment of a strip 26 having perforations 25 and having an occlusal contoured surface 33.

The dental crowns 10 and 10a may be produced in mass by compression molding, vacuum forming, injection molding, pressure forming, or thermoforming.

As previously mentioned, the strengthener 20 or 20a may be a metal crown base 60. Advanced materials may be used or formulated as a layer 50 applied by powder coating, flame spraying, liquid dispersion, compression molding, vacuum forming, injection molding, pressure forming, or thermoforming to all external surfaces 11, 11a and possibly 15, and/or 15a of a dental crown 10 or 10a over the metal (by way of example, but not limited to, stainless steel) crown base 60 (see FIG. 10 where only surface 11 is shown, represented here as occlusal 22 but not limited thereto).

The dental crowns preferably have an undercut; are tooth colored; for primary or permanent; anterior or posterior teeth; and may include internal metal crown, strip or other strengthener(s).

Strips 26 or 26a may be embedded only in the respective circumferential area 24 or circumferential area 24a of the respective dental crown 10 or dental crown 10a.

What is claimed is:

1. A dental crown, comprising:
a strengthener wherein said strengthener is selected from one or more of the group of strengtheners consisting of a metal crown base, a strip and a filler substance; and
an advanced material contiguous with said strengthener;
wherein the advanced material forms at least an outer layer of said dental crown and wherein the outer layer comprises a layer selected from the group of layers consisting of flame sprayed, liquid dispersed, powder coated, compression molded, vacuum formed, injection molded, pressure formed, and thermoformed.

2. The apparatus according to claim 1, wherein said strip is a metal strip having a thickness ranging from about 0.1 to about 0.25 millimeters.

3. The apparatus according to claim 1, wherein said strengthener is a strengthener selected from a group of materials consisting of metal, screen, mesh, fibers, woven fibers, carbon fibers, glass fibers, glass particles, plastic, aramids, preimpregnated carbon-polymer tapes, KEVLAR and combinations thereof.

4. The apparatus according to claim 2, wherein said strip has perforations.

5. The apparatus according to claim 2, wherein said strip has texturing in a surface of said strip.

6. The apparatus according to claim 1, further including a metal strip embedded in the dental crown.

7. The apparatus according to claim 6, further including a center surface and a circumferential area integral with and transitioning from the center surface wherein said metal strip is positioned on the circumferential area of the dental crown.

8. The apparatus according to claim 1, further including a center surface and a circumferential surface define a cavern side of the dental crown;
wherein the cavern side includes a means for enhancing the bond of the dental crown to a tooth.

9. A dental crown, comprising:
a center surface;
a circumferential surface transitioning from and integral with the center surface; and
a strengthener in the dental crown.

10. The apparatus according to claim 9, wherein said strengthener is a strip embedded in the dental crown.

11. The apparatus according to claim 10, wherein said strip is a metal strip having a thickness ranging from about 0.1 to about 0.25 millimeters.

12. The apparatus according to claim 10, wherein said strip has perforations.

13. The apparatus according to claim 10, wherein said strip has texturing in a surface of said strip.

14. The apparatus according to claim 9, wherein said strengthener is a strengthener selected from a group of materials consisting of metal, screen, mesh, fibers, woven fibers, carbon fibers, glass fibers, glass particles, plastic, aramids, preimpregnated carbon-polymer tapes and KEVLAR and combinations thereof.

15. The apparatus according to claim 9, wherein said strengthener is a metal crown base.

16. The apparatus according to claim 15, wherein the dental crown further includes a layer of an advanced material applied to at least one out surface of the metal crown base.

17. The apparatus according to claim 9, wherein the dental crown is made of an advanced material.

18. A method of making the dental crown according to claim 17, wherein the method of making is selected from a group of methods consisting of injection molding, compression molding, pressure forming, vacuum forming, thermoforming, layering by flame spraying, layering by liquid dispersion, and layering by powder coating.

19. A method of making the dental crown according to claim 9, wherein the method of making is selected from a group of methods consisting of injection molding, compression molding, pressure forming, vacuum forming, thermoforming, layering by flame spraying, layering by liquid dispersion, and layering by powder coating.

20. A method of making the dental crown according to claim 15, wherein the method of making is selected from a group of methods consisting of injection molding, compression molding, pressure forming, vacuum forming, thermoforming, layering by flame spraying, layering by liquid dispersion, and layering by powder coating.
